(19) United States
(12) Patent Application Publication
(10) Pub. No.: US 2022/0116520 A1
(43) Pub. Date: Apr. 14, 2022

(54) IMAGE CAPTURE BY IMAGE-CAPTURE DEVICE POSITIONED BEHIND DISPLAY DEVICE

(71) Applicant: Hewlett-Packard Development Company, L.P., Spring, TX (US)

(72) Inventors: Hsing-Hung Hsieh, Taipei City (TW); Alan Man Pan Tam, Spring, TX (US); Kuan-Ting Wu, Taipei City (TW)

(73) Assignee: Hewlett-Packard Development Company, L.P., Spring, TX (US)

(21) Appl. No.: 17/419,006

(22) PCT Filed: Mar. 5, 2019
(86) PCT No.: PCT/US2019/020777

§ 371 Date: Jun. 28, 2021

(51) Int. Cl. H04N 5/225; G09G 3/20; H04N 5/235

(52) U.S. Cl. CPC H04N 5/2257; G09G 3/2096; G09G 2310/0267; G09G 2310/08; G09G 2310/0275; H04N 5/235

(57) ABSTRACT

An image-capture device is positioned behind a display device. A hardware display controller interleaves image frames and black frames for display on the display device. A hardware timing controller synchronizes image capture by the image-capture device with display of the black frames so that the image capture occurs a specified delay after the display device has started displaying each black frame.

### BACKGROUND

Portable computing devices, including laptop, notebook, and convertible computers, as well as tablet computing devices and smartphones, commonly have the capability to capture images of users while the users are viewing the displays of the devices. That is, a portable computing device typically has an image-capture device like a camera on the same side of the device as its display. Users are thus able to capture self portraits (i.e., “selfies”) and videos, as well as engage in video calls and conferences.

### BRIEF DESCRIPTION OF THE DRAWINGS

FIG. 1 is a diagram of an example display system having a display device and an image-capture device positioned behind the display device.

FIGS. 2A, 2B, and 2C are diagrams of examples of how image frames and black frames can be interleaved when an image-capture device positioned behind a display device is to capture images.

FIG. 3 is a diagram of an example as to how a display system displays a frame on a frame line-by-frame line basis on the rows of a display device.

FIG. 4 is a timing diagram of an example of how image capture is synchronized with the display of a frame on a frame line-by-frame line basis on the rows of a display device.

FIG. 5 is a block diagram of an example display system.

FIG. 6 is a flowchart of an example method.

FIG. 7 is a diagram of an example non-transitory computer-readable data storage medium.

### DETAILED DESCRIPTION

As noted in the background section, portable computing devices usually have cameras or other image-capture devices on the same sides as their displays. Traditionally, a portable computing device has had such an image-capture device disposed above the device's display, within a bezel surrounding the display. However, to maximize display size relative to device size or to decrease device size without correspondingly decreasing display size, as well as to provide for a more modern design “look,” manufacturers have been steadily shrinking the bezels surrounding the displays of their portable computing devices. In the most extreme cases, manufacturers have shrunk the bezels to effectively eliminate them, in so-called bezel-less devices.

To still accommodate image-capture devices within such portable computing devices, manufacturers have focused on two different strategies. The first is to reserve a “notch” or “punch hole” towards the top of a device's display for an image-capture device. There is no active display in this reserved area. However, the net result is strange looking to at least some consumers, and the portion of the display around the reserved area is more difficult to usably leverage. For example, when such a portable computing device displays a rectangular image, either a portion of the image corresponding to the “notch” or “punch hole” is not displayed, or the image is resized to fit a smaller rectangular portion of the display that does not overlap the “notch” or “punch hole.”

The second strategy is to position the image-capture device behind the display of a portable computing device. The display can thus still be rectangular, and the device can have little or no bezel. For this strategy to be workable, the display is at least partially transparent in the area behind which the image-capture device is located. Going forward, this second strategy is expected to become more popular than the first strategy as display technology improves and transparent displays decrease in cost, because the resulting portable computing devices have more usable displays and present a cleaner “look” than devices having distracting “notches” or “punch holes.”

However, capturing images using image-capture devices positioned behind displays of portable computing devices is more difficult than when using image-capture devices that are not positioned behind displays, particularly when the displays are currently displaying content. While the display itself may be transparent, light from the display that is used to display content or make the content more visible in an ambient environment can be reflected back into the image-capture device when capturing images. Therefore, captured images of the user of such a portable computing device can appear washed out, or can include artifacts resulting from the content that the device's display was showing when the images were captured.

To avoid this problem, techniques described herein interleave image frames of content with black frames for display on a display device when an image-capture device positioned behind the display device is being used to capture images. The image-capture device captures images just when the black frames are being displayed on the display device, and not when the image frames are being displayed. Therefore, there is no light from the display device that can be reflected back into the image-capture device, improving the quality of the captured images. The captured images can be still photos or images, as well as video (i.e., moving images) that include a successive number of such captured images.

The display device displays a current frame on the rows of the device on a frame line-by-frame line basis. Thus, when the current frame is to be displayed, the first line of the frame is displayed on the first row, then the second line is displayed on the second row, and so on, until the last line of the frame is displayed on the last row of the display. This process is repeated with the next frame, the frame after that, and so on. Therefore, if the sequence of frames to be displayed includes black frames interleaved with image frames, when a black frame is to be displayed following an image frame, the lines of the image frame are replaced with black frame lines on a line-by-line basis starting with the first row of the display, until the image frame has been completely replaced by the black frame lines.

The image-capture device is positioned behind specified rows of the display device. Therefore, the techniques described herein synchronize image capture by the image-capture device with the display of the black frames so that image capture occurs after black frame lines have been displayed on the display device's rows behind which the image-capture device is positioned. This ensures that no image frame lines are still being displayed when image capture occurs. Stated another way, image capture is synchronized with the display of black frames so that image capture occurs a specified delay after the display device has started displaying each black frame.

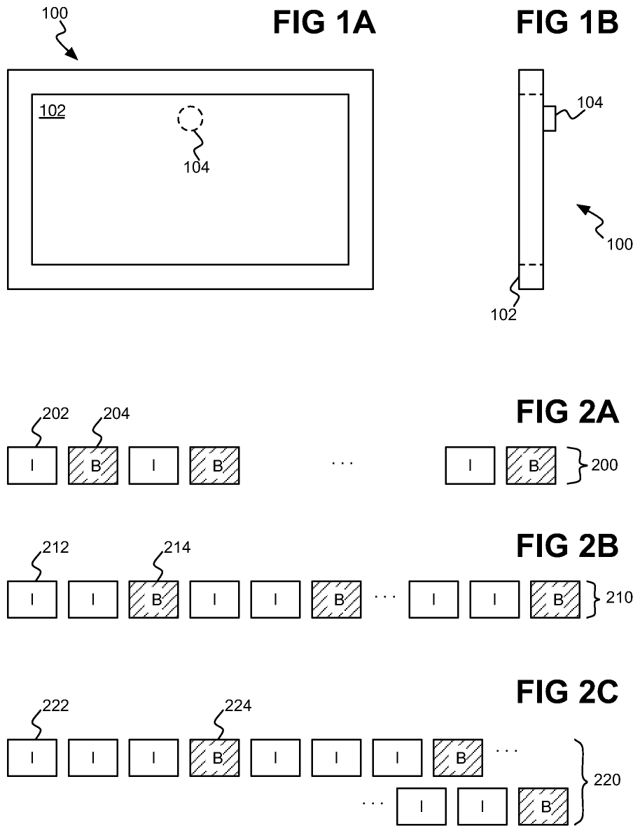

FIG. 1 shows an example display system 100. The display system 100 can be implemented as a standalone external display for a computing device like a desktop, laptop, or notebook computer. The display system 100 can be implemented as an integral part of the computing device itself. Examples of such computing devices include laptop, notebook, and all-in-one (AIO) desktop computers, as well as tablet and convertible computing devices. The display system 100 can be implemented as an integral part of a more portable computing device, such as smartphones, personal digital assistant (PDA) devices, and tablet computing devices.

The display system 100 includes a display device 102, which can also be referred to as a display. The display device 102 can be a flat-panel display device. Examples of such flat-panel display devices include light-emitting diode (LED) display devices, as well as organic LED (OLED) display devices, micro LED display devices, quantum dot display devices like quantum LED (QLED) display devices, and so on.

The display system 100 includes an image-capture device 104 positioned behind a portion of the display device 102. The display device 102 is at least partially transparent in at least the portion behind which the image-capture device 104 is disposed, and may be completely transparent, to permit the image-capture device 100 to capture images from in front of the display device 102. The portion of the display device 102 behind which the image-capture device 104 is positioned is thus an active portion that actually displays content, and is not a bezel, “notch,” “punch hole,” etc., that does not display content. The image-capture device 104 can capture still images as well as moving images (i.e., video). The image-capture device 104 may be referred to as a camera, and may be implemented as a semiconductor image sensor, such as a charge-coupled device (CCD) or complementary metal oxide semiconductor (CMOS) image sensor.

In the example of FIG. 1, the image-capture device 104 is depicted as centered towards the top of the display device 102 when the device 102 is positioned in landscape mode. In landscape mode, the long edges of the display device 102 are on the top and bottom, and the short edges of the device 102 are on the sides. However, the image-capture device 104 can instead be centered towards the top of the display device 102 when the device 102 is positioned in portrait mode. In portrait mode, the short edges of the display device 102 are on the top and bottom, and the long edges of the device 102 are on the sides.

The display system 100 displays images on the display device 102 at a refresh rate, which is the number of times per second the display system 100 can redraw the image that is displayed on the display device 102. The refresh rate is measured as Hertz (Hz). The display device 102 may have a refresh rate of 60, 90, 120, 180, or 240, for example. This means that the display device 102 can display up to 60, 90, 120, 180, or 240 different image frames per second.

When the image-capture device 104 is not being used to capture images from in front of the display device 102, the display device 102 displays (just) image frames of content that the display system 100 generates or is provided. By comparison, when the image-capture device 104 is being used to capture images while the display device 102 is displaying content, black frames are interleaved with these image frames, with the image-capture device 104 specifically capturing images when the black frames are being displayed. That is, when the image-capture device 104 is being used to capture images, the image-capture device 104 specifically does not capture images when the image frames are being displayed.

A black frame is a frame in which the display device 102 does not display any content. For example, a display device 102 typically includes a number of pixel elements, which may each be made up of red, green, and blue sub-pixel elements. When the display device 102 displays content (i.e., an image frame), the sub-pixel elements of each pixel elements are controlled according to a corresponding image frame pixel, so that the image frame is displayed on the display device 102. For an n-bit display device 102—such as an 8-bit or a 24-bit display device 102—each red, green, and blue sub-pixel element of a pixel element can have a value between zero and 2ⁿ−1, so that the corresponding intensities of the red, green, and blue colors of the pixel element realize the full color of the corresponding image frame pixel.

In such an implementation, when the display device 102 displays a black frame, none of the pixel elements of the display device 102 are turned on. This is because the black frame corresponds to when no content is being displayed. The sub-pixel element of each pixel element of the display is turned off (i.e., has a value of zero). If the display device 102 is of a type that has backlighting, such as panel-wide liquid crystal display (LCD) backlighting, full-array LED backlighting, edge LED backlighting, cold-cathode fluorescent lamp (CCFL) backlighting, and/or local-zone dimmable backlighting, the backlighting may be turned off or set to its minimal value.

FIGS. 2A, 2B, and 2C show different examples of interleaving black frames and image frames when the image-capture device 104 is being used to capture images. In FIG. 2A, the display device 102 displays frames 200 including image frames 202 and black frames 204. The image frames 202 and the black frames 204 are interleaved on a 1:1 basis, such that one image frame 202 is displayed, then one black frame 204, then the next image frame 202, then another black frame 204, and so on. If the display device 102 has a refresh rate of n Hz, then when the image-capture device 104 is being used to capture images, the effective maximum frame rate at which the display device 102 can display image frames is n/2 frames per second (fps), and likewise the maximum capture rate at which the image-capture device 104 can capture images is n/2 images per second (ips).

In FIG. 2B, the display device 102 displays frames 210 including image frames 212 and black frames 214. The image frames 212 and the black frames 214 are interleaved on a 2:1 basis, such that two image frames 212 are displayed, then one black frame 214, then the next two image frames 212, then another black frame 214, and so on. If the display device 102 has a refresh rate of n Hz, then when the image-capture device 104 is being used to capture images, the effective maximum frame rate at which the display device 102 can display image frames is 2n/3 fps, and the maximum capture rate at which the image-capture device 104 can capture images is n/3 ips.

In FIG. 2C, the display device 102 displays frames 220 including image frames 222 and black frames 224. The image frames 222 and the black frames 224 are interleaved on a 3:1 basis, such that three image frames 222 are displayed, then one black frame 224, then the next three image frames 222, then another black frame 224, and so on. If the display device 102 has a refresh rate of n Hz, then when the image-capture device 104 is being used to capture images, the effective maximum frame rate at which the display device 102 can display images is 3n/4 fps, and the maximum capture rate at which the image-capture device 104 can capture images is n/4 ips.

How black frames are interleaved with image frames when the image-capture device 104 is to capture images can depend on the refresh rate of the display device 102, the desired effective maximum frame rate at which the display device 102 is to display image frames while the image-capture device 104 is capturing images, and the desired capture rate at which the image-capture device 104 is to capture images. As one example, if the display device 102 has a relatively high refresh rate, such as 120 Hz or more, then interleaving image and black frames on a 1:1 basis may permit image capture at a high capture rate while still displaying image frames at a high effective frame rate. As a second example, if the display device 102 has a relatively low refresh rate, such as 60 Hz, then image frame and black frames may be interleaved on a 2:1 or even 3:1 basis to ensure that image frames are still displayed relatively fluidly such that most users will not be able to perceive the decrease in frame rate, although the capture rate may be slightly less fluid and thus perceivable.

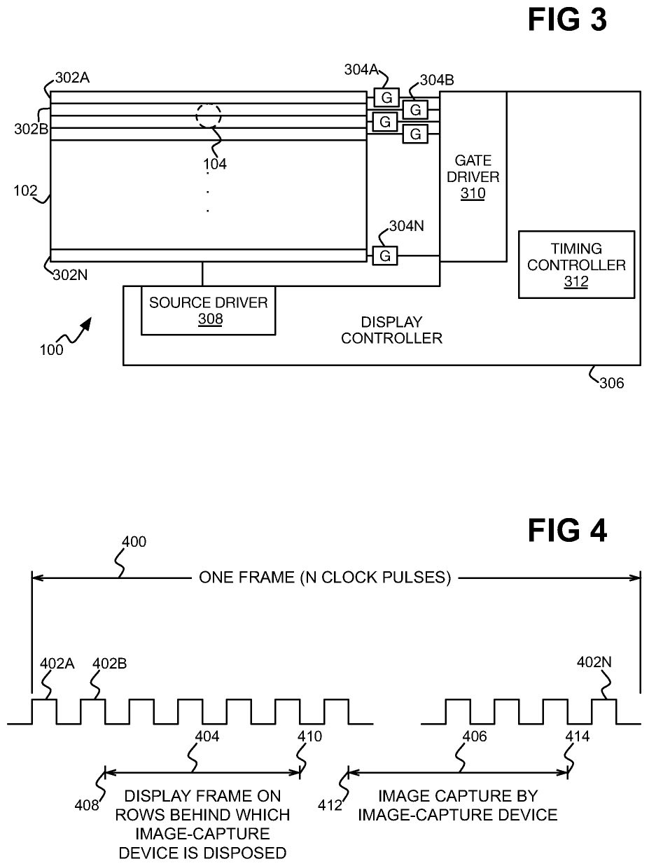

FIG. 3 shows an example of how the display system 100 displays a frame in detail. The display device 102 includes rows 302A, 302B, . . . , 302N, collectively referred to as the rows 302. For example, a 1080p display device 102 has 1,080 rows 302, whereas a 720p display device 102 has 720 rows 302, and a 4K display device 102 typically has 2,160 rows 302. The display device 102 does not display the entirety of a frame immediately or simultaneously. Rather, the display device 102 displays a frame on a frame line-by-frame line basis. A frame has frame lines corresponding and equal in number to the rows 302 of the display device 102. Therefore, to display a frame, the display device 102 successively displays the lines of the frame on corresponding rows 302 of the device 102 until the frame has been completely displayed.

A refresh rate of n Hz means that the display device 102 takes 1/n seconds to completely display the frame. Therefore, there is a 1/n second delay between when the display device 102 starts displaying the first frame line on the first row 302A until the device 102 finishes displaying the last frame line on the last row 302N. If there are N rows 302, a frame line of a current frame is displayed every 1/Nn seconds on a corresponding row 302, until all the frame lines of the current frame have been displayed.

The image-capture device 104 is positioned behind a number of the rows 302 of the display device 102. For example, the image-capture device 104 may be positioned behind ten rows 302, such as the third through thirteenth rows 302 of the display device 102. In this respect, Applicant notes that the FIG. 3 is not drawn to scale. Rather, the rows 302 of the display device 102 are displayed larger than they actually are for illustrative clarity.

The display system 100, in addition to the display device 102 and the image-capture device 104, includes gates 304A, 304B, . . . , 304N, which are collectively referred to as the gates 304. Each gate 304 corresponds to a different row 302 of the display device 102. Selecting (i.e., selectively activating) a given gate 304 causes a current frame line to be loaded into (i.e., displayed by) the row 302 to which the given gate 304 corresponds. Therefore, the gates 304 are successively individually activated to display the frame lines of the current frame on the rows 302 of the display device 102.

The display system 100 also includes a display controller 306. The display controller 306 is implemented in hardware, and thus can be an application-specific integrated circuit (ASIC), for instance. The display controller 306 may include a hardware processor that executes microcode or other program code. However, that the display controller 306 is said to execute program code includes implementation in which the display controller 306 is an ASIC or other integrated circuit designed to perform the functionality described herein.

The display controller 306 in the example of FIG. 3 includes a source driver 308, a gate driver 310, and a timing controller 312, all of which can be implemented in hardware. In different implementations, one or more of the drivers 308 and 310 and the controller 312 may be separate from the display controller 306. The source driver 308 loads a current frame line of the current frame to be displayed on a corresponding row 302 of the display device 102. The gate driver 310 successively individually activates the gates 304 as the frame lines are loaded into the source driver 308 to display the frame lines on the rows 302.

For example, the source driver 308 loads the first frame line of the current frame, and then gate driver 310 activate the gate 304A to cause the display device 102 to display this first frame line in the row 302A by transferring or loading the first frame line from the source driver 308 to the row 302A. The source driver 308 then loads the second frame line of the current frame, with the gate driver 310 activating the gate 304B to transfer the second frame line from the source driver 308 to the row 302B. This process continues on a frame line-by-frame line basis to display the frame lines of the current frame on the rows 302 of the display device 102. Display of the current frame on the display device 102 finishes with the source driver 308 loading the last frame line of the current frame and the gate driver 310 activating the gate 304N to transfer the last frame line from the source driver 308 to the row 302N.

The timing controller 312 outputs a sequence of clock pulses that controls loading of frame lines by the source driver 308 and activation of the gates 304 by the gate driver 310 to successively display the frame lines on the rows 302 of the display device 102. At each clock pulse, the source driver 308 loads a frame line of the current frame, and the gate driver 310 activates a gate 304 to transfer the loaded frame line into the row 302 corresponding to the gate 304. Therefore, if the display device 102 has a refresh rate of n Hz and has N rows 302, the timing controller 312 outputs clock pulses every 1/nN seconds, so that a gate 304 is activated every 1/nN seconds to display an image frame line on a row 302 every 1/nN seconds.

FIG. 4 shows an example as to how the hardware timing controller 312 synchronizes image capture by the image-capture device 104 with display of a black frame by the display device 102 on an image line-by-image line basis. As noted above, when the image-capture device 104 is being used to capture images, the image-capture device 104 specifically captures images when black frames are being displayed. However, as also noted above, a frame—including a black frame—does not have its frame lines simultaneously displayed on the display device 102. Rather, when a frame is displayed on the display device 102, the frame lines of the frame are successively displayed on the rows 302 of the display device 102, every 1/nN seconds, until the frame has been completely displayed.

In FIG. 4, there is a sequence of clock pulses 402A, 4026, . . . , 402N, collectively referred to as the clock pulses 402, corresponding to the time period 400 it takes to display a frame. The time period 400, for a refresh rate of n Hz, is equal to 1/n seconds. There are N number of clock pulses 402 corresponding to the N number of rows 302 of the display device. When a black frame is to be displayed, at clock pulse 402A, a black frame line is displayed on the first row 302A of the display device 302; at clock pulse 402B, a black frame line is displayed on the second row 302B; and so on, until at the last clock pulse 402N for the time period 400 it takes to display the black frame, a black frame line is displayed on the last row 302N.

Within the time period 400 is a time period 404 during which black frame lines are displayed on the rows 302 behind which the image-capture device 104 is disposed. The time period 404 has a start time 408 and an end time 410. The start time 408 corresponds to the clock pulse 402 at which a black frame line is displayed on the first row 302 behind which the image-capture device 104 is disposed, and the end time 410 corresponds to the clock pulse 402 at which a black frame line is displayed on the last row 302 behind which the image-capture device 104 is disposed.

For example, if the image-capture device 104 is disposed behind the third through thirteenth rows 302 of the display device 102, the start time 408 of the time period 404 corresponds to the third clock pulse 402 at which a black frame line is displayed on the third row 302. The end time 410 of the time period 404 in this example corresponds to the thirteenth clock pulse 402 at which a black frame line is displayed on the thirteenth row 302. It is noted that FIG. 4 is not drawn to scale in this respect.

The display controller 306 does not cause the image-capture device 104 to begin capturing an image until after the clock pulse 402 corresponding to the end time 410 of the time period 404. That is, the display controller 306 does not cause the image-capture device 104 to begin capturing an image until black frame lines have been displayed on all the rows 302 behind which the image-capture device 104 is positioned. Stated another way, the display controller 306 displays the capture of an image by the image-capturing device 104 until black frame lines have been displayed on all the rows 302 behind which the image-capture device 104 is positioned. Therefore, even when a black frame is being displayed on the display device 102—in that the display device 102 has begun to display a black frame—the image-capture device 104 does not begin image capture until black frame lines have been displayed on the rows 302 behind which the device 104 is disposed.

In FIG. 4, there is a time period 406 within the time period 400, during which image capture by the image-capture device 104 occurs. The time period 406 has a start time 412 and an end time 414. The start time 412 corresponds to the clock pulse 402 at which image capture by the image-capture device 104 begins, and the end time 414 corresponds to the clock pulse 402 at which image capture ends.

The start time 412 of the time period 406 during which image capture occurs is after the end time 410 of the time period 404 during which black frame lines are displayed on the rows 302 behind which the image-capture device 104 is disposed. In the specific example of FIG. 4, the start time 412 does not coincide with the first pulse 402 after the end time 410. Rather, the image-capture device 104 begins image capture at a number of clock pulses 302 after the black frame line has been displayed on the last row 302 behind which the image-capture device 104 is disposed. Such an additional delay can compensate for any image retention by the display device 102 between when a black frame line is loaded into a row 302 of the display device 102 and when the row 302 actually displays the black frame line.

In general, then, the start time 412 of the time period 406 during which image capture occurs can be configured or specified to coincide with a given clock pulse 402 after the clock pulse 402 corresponding to the end time 410 of the time period 404. That is, the start time 412 can begin at the first clock pulse 402 after the clock pulse 402 corresponding to the end time 410 of the time period 404, or at a specified number of clock pulses 402 after the clock pulse 402 corresponding to the end time 410. It can thus be said that the image capture by the image-capture device 104 is synchronized with the display of black frames so that image capture begins a specified delay after the display device 102 has started displaying each black frame. This specified delay is the length of time between the start of the first clock pulse 402A and the start time 412, which is configurable so long the start time 412 is after the end time 410. The specified delay thus corresponds to the display device 102 having already displayed black frame lines on at least the rows of the display device 102 behind which the image-capture device 104 is positioned.

The end time 414 of the time period 406 during which image capture occurs is likewise configurable, and may depend on how long it takes for the image-capture device 104 to fully capture an image once the device 104 has begun capturing the image at the start time 412. The end time 414 may be configured or specified to correspond to any clock pulse 402 through the last clock pulse 402N of the time period 400 in which the black frame is displayed. Therefore, at the start time 412 of the time period 406, the hardware display controller 306 may turn on or otherwise cause the image-capture device 104 to begin image capture, and at the end time 414 the display controller 306 may turn off or otherwise cause the image-capture device 104 to stop image capture.

At each clock pulse 402, then, the hardware display controller 306 displays a corresponding line of a current frame on the row 302 of the display device 102 corresponding to the clock pulse 402. When the current frame is a black frame, the display controller 306 causes the image-capture device 104 to begin image capture at the clock pulse 402 corresponding to a first selected row 302 of the display device 102. This first selected row can be the row 302 of the display device 102 immediately following the last row 302 behind which the image-capture device 104 is positioned, or one or more rows 302 after the last row 302 behind which the image-capture device 104 is positioned.

The display controller 306, again when the current frame is a black frame, causes the image-capture device 104 to end image capture at the clock pulse 402 corresponding to a second selected row 302 of the display device 102. This second selected row 302 is after the first selected row 302, since image capture is stopped after it has been started. The selected row 302 is further before the last row 302 of the display.

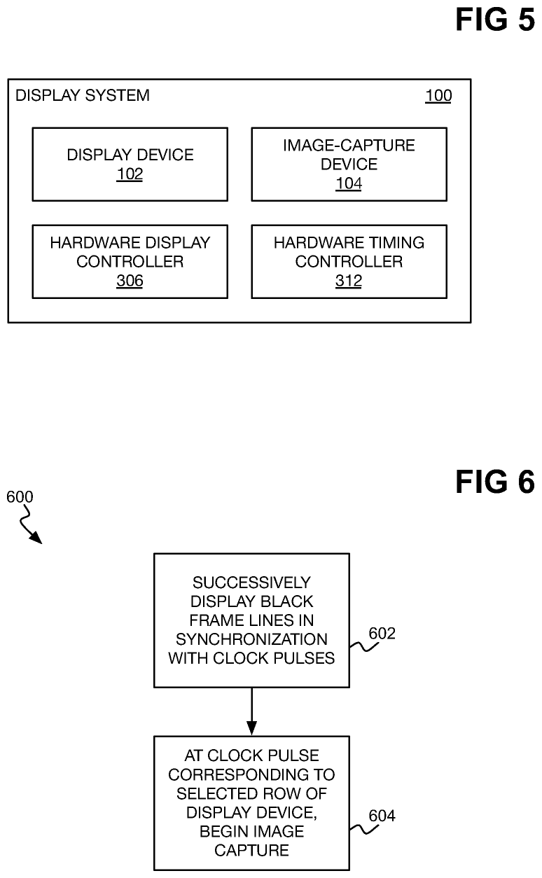

FIG. 5 shows a block diagram of the example display system 100. The display system includes the display device 102, the image-capture device 104, the hardware display controller 306, and the hardware timing controller 312 that have been described. The image-capture device 104 is positioned behind the display device 102. The hardware display controller 306 interleaves image frames and black frames for display on the display device 102. The hardware timing controller 312 synchronizes image capture by the image-capture device 104 with display of the black frames so that image capture occurs after a specified delay after the display device 102 has started displaying each black frame.

FIG. 6 shows an example method 600. The method 600 can be performed by the display system 100. The method 600 includes successively displaying black frame lines of a black frame on corresponding rows 302 of the display device 102, in synchronization with corresponding clock pulses 402 for the black frame (602). The method 600 includes, at the clock pulse 402 corresponding to a selected row 302 of the display device 102, causing the image-capture device 104 positioned behind the display device 102 to begin image capture (604). The clock pulse 402 corresponding to the selected row 302 is the clock pulse 402 with which the start time 412 of the time period 406 in FIG. 4 is aligned.

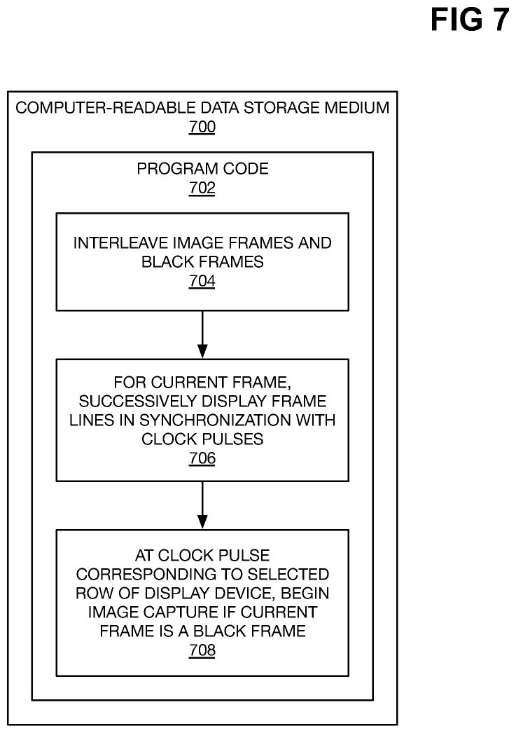

FIG. 7 shows an example computer-readable data storage medium 700. The storage medium 700 stores program code 702. The display controller 306 executes the program code 602 to perform processing. The processing includes interleaving image frames and black frames for display on the display device 102 (704). The processing includes, for a current frame, successively displaying frame lines of the current frame on corresponding rows 302 of the display device 102, in synchronization with corresponding clock pulses 402 for the current frame (706). The processing includes, when the current frame is a black frame, cause the image-capture device 104 disposed behind the display device 102 to begin image capture at the clock pulse 402 corresponding to a selected row 302 of the display device 102 (708). As noted above, the clock pulse 402 corresponding to the selected row 302 is the clock pulse 402 with which the start time 412 of the time period 406 in FIG. 4 is aligned.

The techniques that have been described herein provide for image capture by an image-capture device 104 positioned behind a display device 102 at an active display area of the device 102. This is achieved by interleaving black frames with image frames of the content that the display device 102 is displaying, and causing the image-capture device 104 to capture images just when the display device 102 is displaying black frames. More specifically, when the display device 102 has begun displaying the frames lines of a black frame, the image-capture device 104 does not being capturing an image until the display device 102 has displayed the black frame lines corresponding to the rows 302 of display device 102 behind which the image-capture device 104 is positioned.

We claim:

1. A display system comprising:
a display device;
an image-capture device positioned behind the display device;
a hardware display controller to interleave a plurality of image frames and a plurality of black frames for display on the display device; and
a hardware timing controller to synchronize image capture by the image-capture device with display of the black frames so that the image capture occurs a specified delay after the display device has started displaying each black frame.

2. The display system of claim 1, wherein the specified delay corresponds to the display device having already displayed black frame lines on at least corresponding rows of the display device behind which the image-capture device is positioned.

3. The display system of claim 1, wherein for a current frame, the hardware timing controller is to output a plurality of clock pulses corresponding to the rows of the display,
wherein, at each clock pulse, the hardware display controller is to display a corresponding line of a current frame on the row corresponding to the clock pulse, wherein the image-capture device is positioned behind a sub-plurality of rows of the plurality of rows of the display,
and wherein, when the current frame is one of the black frames, the hardware display controller is to, at the clock pulse corresponding to a first selected row of the display, cause the image-capture device to begin the image capture.

4. The display system of claim 3, wherein the first selected row is the row of the display device immediately following a last row of the sub-plurality of rows behind which the image-capture device is positioned.

5. The display system of claim 3, wherein the first selected row is a specified number of rows after a last row of the sub-plurality of rows behind which the image-capture device is positioned to compensate for image retention by the display device.

6. The display system of claim 3, wherein, when the current frame is one of the black frames, the hardware display controller is to, at the clock pulse corresponding to a second selected row of the display, causing the image-capture device to stop the image capture,
and wherein the second selected row is between the first selected row and a last row of the display.

7. The display system of claim 3, further comprising a plurality of gates corresponding to the rows of the display, wherein the hardware display controller comprises:
a source driver to, for each clock pulse, load the corresponding line of the current frame; and
a gate driver to, for each clock pulse, selectively activate the gate for the row corresponding to the clock pulse to display the corresponding line loaded in the source driver on the row corresponding to the clock pulse.

8. The display system of claim 7, wherein the hardware timing controller is part of the hardware display controller.

9. A method comprising:
successively display a plurality of black frame lines of a black frame on a corresponding plurality of rows of a display device, in synchronization with a corresponding plurality of clock pulses for the black frame; and
at the clock pulse corresponding to a first selected row of the display device, cause an image-capture device positioned behind the display device to begin image capture.

10. The method of claim 9, wherein the image-capture device is positioned behind a sub-plurality of rows of the plurality of rows of the display,
and wherein the first selected row is the row of the display device immediately following a last row of the sub-plurality of rows behind which the image-capture device is positioned.

11. The method of claim 9, wherein the image-capture device is positioned behind a sub-plurality of rows of the plurality of rows of the display,
and wherein the first selected row is a specified number of rows after a last row of the sub-plurality of rows behind which the image-capture device is positioned to compensate for image retention by the display device.

12. The method of claim 9, further comprising:
at the clock pulse corresponding to a second selected row of the display device, cause the image-capture device positioned behind the display device to end the image capture,
wherein the second selected row is between the first selected row and a last row of the display.

13. A non-transitory computer-readable data storage medium storing program code executable by a hardware display controller to:
interleave a plurality of image frames and a plurality of black frames for display on a display device;
for a current frame, successively display a plurality of frame lines of the current frame on a corresponding plurality of rows of a display device, in synchronization with a corresponding plurality of clock pulses for the current frame; and
when the current frame is one of the black frames, cause an image-capture device positioned behind the display device to begin image capture at the clock pulse corresponding to a first selected row of the display device.

14. The non-transitory computer-readable data storage medium of claim 13, wherein the image-capture device is positioned behind a sub-plurality of rows of the plurality of rows of the display,
and wherein the first selected row is the row of the display device immediately following a last row of the sub-plurality of rows behind which the image-capture device is positioned.

15. The non-transitory computer-readable data storage medium of claim 13, wherein the image-capture device is positioned behind a sub-plurality of rows of the plurality of rows of the display,
and wherein the first selected row is a specified number of rows after a last row of the sub-plurality of rows behind which the image-capture device is positioned to compensate for image retention by the display device.
